(19) United States
(12) Patent Application Publication
(10) Pub. No.: US 2009/0013869 A1
(43) Pub. Date: Jan. 15, 2009

(54) PROCESS AND DEVICE FOR PRODUCING A PRESSURIZED GASEOUS PRODUCT BY LOW-TEMPERATURE SEPARATION OF AIR

(76) Inventors: Dietrich Rottmann, Munchen (DE); Christian Kunz, Munchen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/168,511

(22) Filed: Jul. 7, 2008

(30) Foreign Application Priority Data
Jul. 7, 2007 (DE) 102007031759.1

(51) Int. Cl. B01D 53/18

(52) U.S. Cl. 95/42

(57) ABSTRACT

The process and the device are used to produce a pressurized gaseous product by low-temperature separation of air in a distillation system, which has at least one high-pressure column (7) and one low-pressure column (8). A process air stream is compressed in a main air compressor. At least a part of the compressed process air stream (1) is introduced (6) into the high-pressure column (7). A first air stream (10, 13, 14, 17, 18), which is formed at least by a part of the process air stream (1), is compressed to a high air pressure (11, 15), which is at least 1 bar above the operating pressure of the high-pressure column (7). A liquid product stream (21, 47) is removed from the distillation system, brought (48, 51) to an elevated pressure in the liquid state, and evaporated or pseudo-evaporated with the first air stream (17) under this elevated pressure by indirect heat exchange (4), and finally drawn off as a gaseous product stream (50, 53). The first air stream (17) is condensed or pseudo-condensed in the indirect heat exchange (4). The first air stream (18) is evaporated downstream from the indirect heat exchange (4) with the product stream (49, 52), which is pressurized in the liquid state, in indirect heat exchange (20) with a gaseous stream (41) from the upper section of the high-pressure column (7). The evaporated first air stream (22) is recycled (23, 26) into the process air stream (1, 2). The evaporated first air stream (23) is compressed in a recompressor (24) upstream from where it is recycled into the process air stream.

The invention relates to a process for producing pressurized gaseous oxygen by low-temperature separation of air according to the introductory clause of claim 1.

Processes and devices for low-temperature separation of air are known from, for example, Hausen/Linde, Tieftemperaturtechnik [Low-Temperature Technology], 2^{nd} Edition 1985, Chapter 4 (pages 281 to 337).

The distillation system of the invention can be designed as a two-column system (for example as a standard Linde double-column system) or else as a three-column or multiple-column system. In addition to the columns for nitrogen-oxygen separation, additional devices can be provided to recover other air components, in particular noble gases, for example an argon or a krypton-xenon recovery.

The invention relates in particular to a process in which at least one pressurized gaseous product is recovered by a liquid product stream being removed from the distillation system for nitrogen-oxygen separation, brought to an elevated pressure in the liquid state, and evaporated under this elevated pressure by indirect heat exchange or pseudo-evaporated (at supercritical pressure). Such internal compression processes are known from, for example, DE 830805, DE 901542 (U.S. Pat. No. 2,712,738U.S. Pat. No. 2,784,572), DE 952908, DE 1103363 (U.S. Pat. No. 3,083,544), DE 1112997 (U.S. Pat. No. 3,214,925), DE 1124529, DE 1117616 (U.S. Pat. No. 3,280,574), DE 1226616 (U.S. Pat. No. 3,216,206), DE 1229561 (U.S. Pat. No. 3,222,878), DE 1199293, DE 1187248 (U.S. Pat. No. 3,371,496), DE 1235347, DE 1258882 (U.S. Pat. No. 3,426,543), DE 1263037 (U.S. Pat. No. 3,401,531), DE 1501722 (U.S. Pat. No. 3,416,323), DE 1501723 (U.S. Pat. No. 3,500,651), DE 2535132 (U.S. Pat. No. 4,279,631), DE 2646690, EP 93448 B1 (U.S. Pat. No. 4,555,256), EP 384483 B1 (U.S. Pat. No. 5,036,672), EP 505812 B1 (U.S. Pat. No. 5,263,328), EP 716280 B1 (U.S. Pat. No. 5,644,934), EP 842385 B1 (U.S. Pat. No. 5,953,937), EP 758733 B1 (U.S. Pat. No. 5,845,517), EP 895045 B1 (U.S. Pat. No. 6,038,885), DE 19803437 A1, EP 949471 B1 (U.S. Pat. No. 6,185,960 B1), EP 955509 A1 (U.S. Pat. No. 6,196,022 B1), EP 1031804 A1 (U.S. Pat. No. 6,314,755), DE 19909744 A1, EP 1067345 A1 (U.S. Pat. No. 6,336,345), EP 1074805 A1 (U.S. Pat. No. 6,332,337), DE 19954593 A1, EP 1134525 A1 (U.S. Pat. No. 6,477,860), DE 10013073 A1, EP 1139046 A1, EP 1146301 A1, EP 1150082 A1, EP 1213552 A1, DE 10115258 A1, EP 1284404 A1 (US 2003051504 A1), EP 1308680 A1 (U.S. Pat. No. 6,612,129 B2), DE 10213212 A1, DE 10213211 A1, EP 1357342 A1 or DE 10238282 A1.

In the heat exchange with the (pseudo-)evaporating product stream, in most cases a part of the process air (referred to here as “first air stream”) is condensed or pseudo-condensed, and, after expansion in a throttle valve or a liquid turbine, it is fed in liquid form into the high-pressure column and/or the low-pressure column of the distillation system. This air that is fed in liquid form reduces the amount of gaseous air that is first fractionated in the high-pressure column, and thus weakens rectification. In particular, in the case of rectification, an amount of liquid nitrogen that is required as a reflux liquid in the high-pressure column and low-pressure column and that is smaller—in comparison to processes with gaseous injection of total air—accumulates. This is more significant in particular in processes with elevated operating pressure (5.5 to 15 bar, preferably 8 to 10 bar at the top of the high-pressure column, and 1.3 to 6 bar, preferably 3 to 4 bar, at the top of the low-pressure column), which are used, for example, in the integrated systems with carbon, heavy oil or biomass gasification and combustion of the fuel that is produced in the gasification in the combustion chamber of a gas turbine system. Here, the product purities required by regulation can no longer be reached without additional measures. As such additional measures, a process with bottom heating of the high-pressure column (EP 1750074 A1) was already proposed. EP 752566 B1 proposes a process with a secondary condenser for liquefying top nitrogen of the high-pressure column and recycling the air that is evaporated in this case to an intermediate stage of the main air compressor and is considered here as the closest prior art.

The object of the invention is to structure such a process and a corresponding device in an especially advantageous manner economically.

This object is achieved by the features of claim 1. Preferably, the total air condensed within the framework of internal compression is evaporated in the indirect heat exchange with the gaseous stream from the upper section of the high-pressure column. The evaporated air is heated in particular in the main heat exchanger, in which the process air is also cooled, and the product stream is (pseudo-)evaporated and heated. Then, in the recompressor, it is separately brought to a suitable pressure to feed it into the air line. The recompressed amount of air now takes part in rectification in the high-pressure column.

The gaseous stream is preferably formed by nitrogen from the top of the high-pressure column. The latter is condensed from the evaporating air and can be used as reflux in the high-pressure column and/or low-pressure column. In the high-pressure column, enough reflux remains that the additional amount of air can be rectified to a high N2 purity in the high-pressure column. The remainder is used as additional reflux in the low-pressure column and improves rectification there.

Preferably, the indirect heat exchange of the first air stream with the gaseous stream from the upper section of the high-pressure column is performed in a secondary condenser. A “secondary condenser” is defined here as a condenser-evaporator that is separated from other heat exchangers and through which no additional fluids flow.

It is especially advantageous if, in the process of the invention, a second air stream, which is formed by a part of the process air stream, is actively depressurized and at least a part of the mechanical energy that is produced in this case is used to drive the recompressor. Thus, no energy needs to be imported for the recompression of the first air stream, as would be the case in a motor drive or in the recompression, known from EP 752566 B1, in the main air compressor.

In addition, the invention relates to a device for producing pressurized gaseous product by low-temperature separation of air according to claim 7.

Other preferred embodiments of the process according to the invention can be found in the other dependent claims.

### BRIEF DESCRIPTION OF DRAWINGS

The invention as well as additional details of the invention are explained in more detail below based on the embodiments that are depicted in the drawings. In this connection:

FIG. 1 shows a first embodiment of the process according to the invention with actuation of the recompressor by a medium-pressure turbine,

FIG. 2 shows a second embodiment with a two-stage recompression,

FIG. 3 shows a third embodiment, in which the turbine is operated at a high pressure as inlet pressure,

FIG. 4 shows a fourth embodiment with argon recovery,

FIG. 5 shows another embodiment with an externally driven recompressor, and

FIG. 6 shows a sixth embodiment with blast turbines.

Process steps that correspond to one another are provided with the same reference numbers in the drawings.

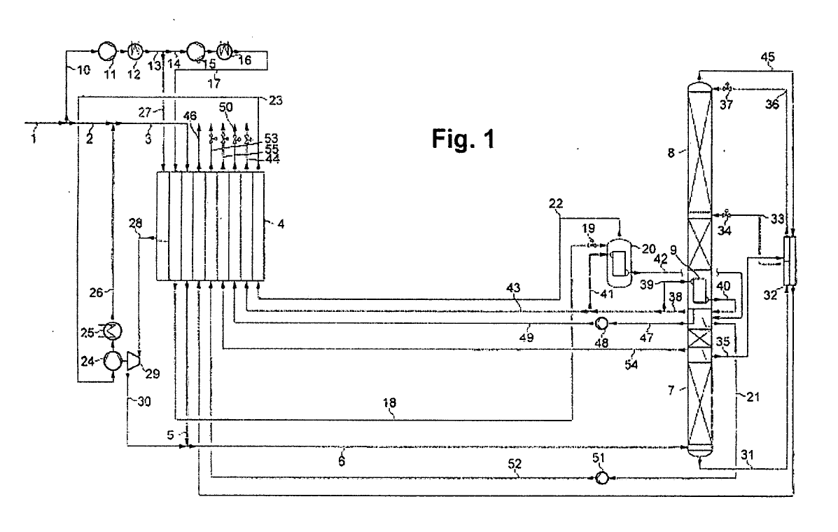

The main air compressor is not shown in FIG. 1, nor is the purification device behind it. The process air stream 1 that is compressed in the main air compressor to a second pressure of 5.5 to 15 bar, preferably about 9 bar, and then compressed is introduced into a first part 2 as a direct air stream via the lines 3, 5, 6 and into the main heat exchanger 4 in the high-pressure column 7 of a distillation system, which in addition has a low-pressure column 8 and a main condenser 9. The operating pressures are 5.5 to 15 bar, preferably about 9 bar, in the high-pressure column, and 1.3 to 6 bar, preferably about 3.5 bar, in the low-pressure column (in each case at the top).

A second part 10 of the process air stream 1 is further compressed in a first recompressor 11 with a secondary condenser 12 to a second pressure of 30 to 50 bar, preferably about 40 bar. A part 14 of the air that is further compressed to the second pressure forms the “first air stream.” The latter is further compressed to a third pressure (the “high pressure”) of 40 to 80 bar, preferably about 60 bar, in a second recompressor 15 with a secondary condenser 16. Via line 17, the first air steam is conveyed to the hot end of the main heat exchanger 4, cooled there, and (pseudo-)condensed. The cold high-pressure air 18 is completely evaporated after Joule-Thompson expansion to 3.5 to 9.5 bar, preferably about 6 bar, in a secondary condenser 20 and returned via line 22 to the cold end of the main heat exchanger 4. The heated first air stream is recompressed according to the invention in a recompressor 24 with a secondary condenser 25 to the first pressure and purified with the direct air stream 2.

Another part 27 of the air 13 under the second pressure forms the “second air stream.” The latter is cooled in the main heat exchanger 4 only to an intermediate temperature and then flows via line 28 to an expander 29, which is designed as a turbo-expander in the embodiment. There, it is actively depressurized to approximately the first pressure. The depressurized second air stream 30 flows together with the direct air stream 5 via line 6 to the high-pressure column 7.

From the bottom of the high-pressure column 7, liquid crude oxygen 31 is drawn off, cooled in a subcooling countercurrent device 32, and released via line 33 and butterfly valve 34 of the low-pressure column 8 to an intermediate point. Liquid impure nitrogen 35 is removed from the high-pressure column 7 at an intermediate point, also cooled in the subcooling countercurrent device 32, and released via line 36 and butterfly value 37 to the top of the low-pressure column 7.

Gaseous top nitrogen 38 of the low-pressure column 8 is essentially completely condensed in a first part 39 in the main condenser. The condensate that is formed in this case is returned via line 40 to the top of the high-pressure column. A second part 41 is essentially completely condensed in the secondary condenser in indirect heat exchange with the first air stream. The condensate that is formed in this case is returned via line 42 to the top of the high-pressure column. A third part 43 of the gaseous top nitrogen 38 of the high-pressure column 7 is heated in the main heat exchanger 4 to approximately ambient temperature and released via line 44 as gaseous nitrogen product under medium pressure.

Gaseous impure nitrogen is drawn off via line 45 from the top of the low-pressure column 8, and after heating in subcooling countercurrent device 32 and in the main heat exchanger 4, it is drawn off via line 46. It can be used, for example, in an evaporative condenser or in the purification device, not shown, as a regeneration gas.

Liquid oxygen 47 is drawn off as a “liquid product stream” from the bottom of the low-pressure column, brought in an oxygen pump 48 to a pressure of 5-50 to 100 bars, preferably about 30 bars, fed via line 49 to the main heat exchanger 4, (pseudo-)evaporated there, and heated to approximately ambient temperature, and finally drawn off via line 50 as a gaseous product stream.

In addition to this internal oxygen compression, the system of the embodiment also has an internal nitrogen compression. In this connection, liquid nitrogen 21 is drawn off from the top of the high-pressure column 7 (or alternatively from the main condenser 9) as another “liquid product stream,” brought in a nitrogen pump 51 to a pressure of 5-50 to 100 bars, preferably about 30 bars, fed via line 52 to the main heat exchanger 4, (pseudo-)evaporated there, and heated to approximately ambient temperature, and finally drawn off via line 53 as another gaseous product stream.

In addition, gaseous impure nitrogen is drawn off from the high-pressure column 7 via line 54, heated, and drawn off via line 55.

The expander 29 and the recompressor 24 are coupled mechanically via a common shaft.

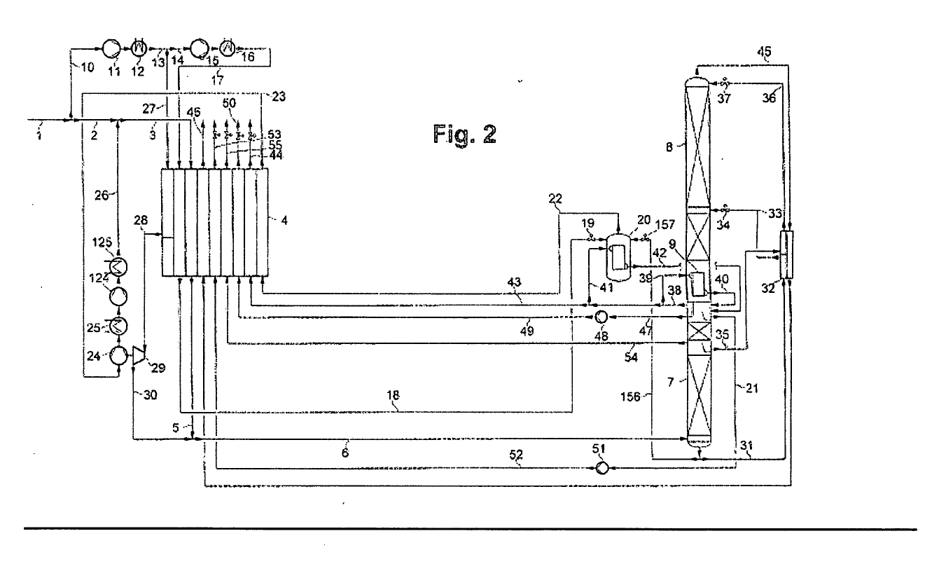

At lower process pressures, for example 5.5 to 9 bar, preferably about 8 bar in the high-pressure column 7, the secondary compression is no longer sufficient for the first recompressor 24, which is designed as a turbine booster. In this case—as shown in FIG. 2—a second recompressor 124 with a secondary condenser 125 is downstream in order to bring the evaporated first air stream 23 to the first pressure that prevails in the lines 1 and 2.

In addition, FIG. 2 is distinguished from FIG. 1 by the line 156 with butterfly valve 157. For this purpose, in addition to the first air stream 18, a part of the liquid crude oxygen is conveyed from the bottom of the high-pressure column 7 into the evaporation chamber of the secondary condenser 20. For this purpose, more nitrogen 41/42 can correspondingly be condensed.

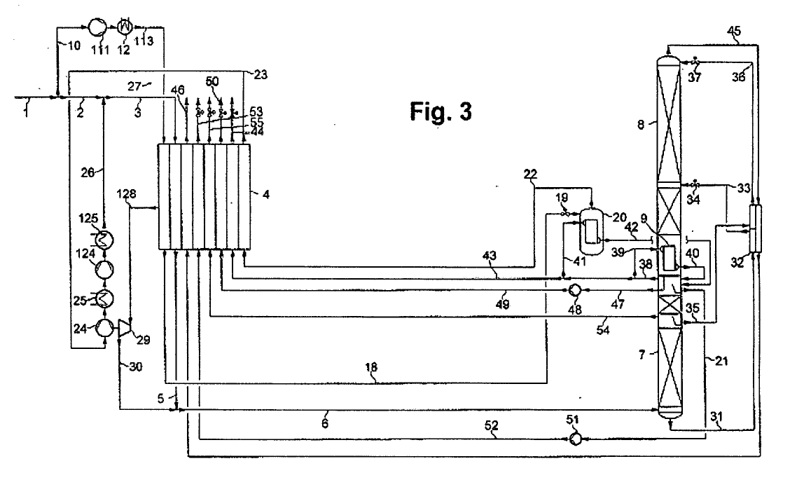

FIG. 3 is based on FIG. 1 and in addition shows the two-stage recompression 24/124 of FIG. 2. In addition, the entire air stream 10 in the recompressor 11 is compressed here to the high pressure. The division of turbine air 128 and the first air stream 18 is performed first at the intermediate temperature of the main heat exchanger 4. To this end, a correspondingly higher inlet pressure is produced at the expander 29.

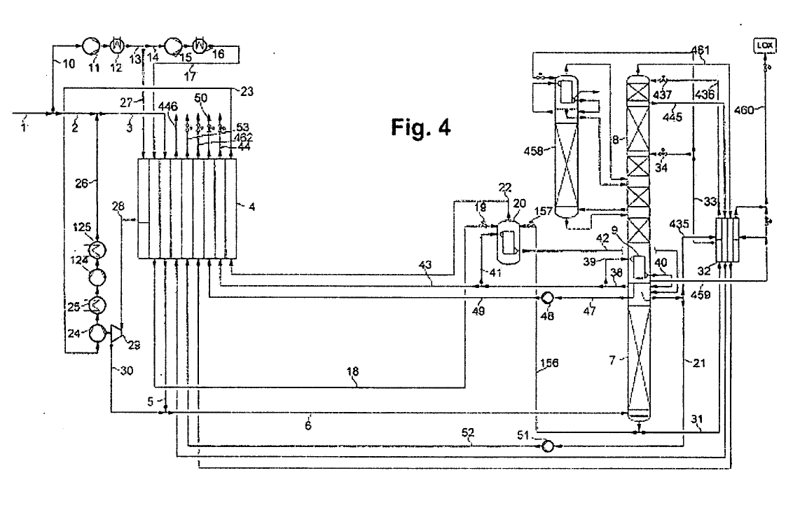

FIG. 4 is based on FIG. 2 and in addition has a crude argon column 458 as a first stage of an argon recovery. In addition, the liquid oxygen is drawn off via the lines 459 and 460 from the bottom of the low-pressure column 8 as a liquid product (LOX). The liquid reflux 435, 436, 437 for the low-pressure column 8 is drawn off here from the top of the high-pressure column 7. Accordingly, a gaseous impure nitrogen 445/446 is removed here from an intermediate point of the low-pressure column 8. The pure top nitrogen 461 of the low-pressure column 8 is also heated and drawn off via line 462 as a product.

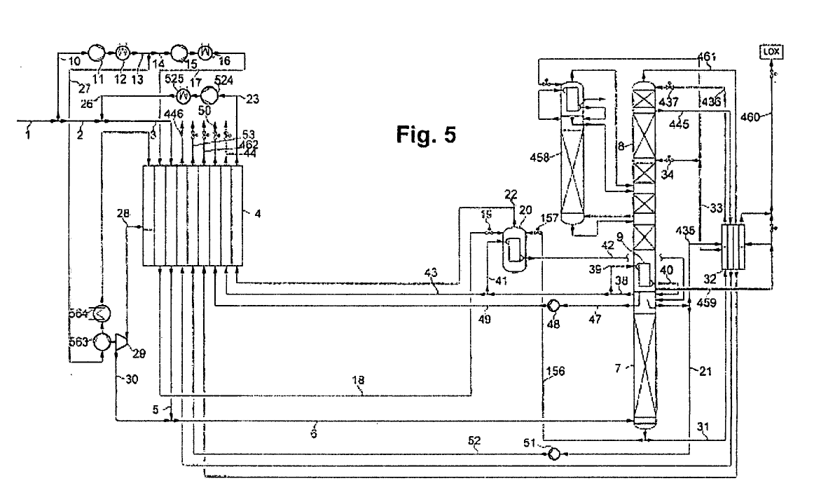

FIG. 5 deviates from FIG. 4 in that the recompressor 524 is not coupled to the expander 29 but rather is driven externally. The recompressor 524 is preferably designed in two stages here. The turbine booster 563 is used here to further increase the pressure in the second air stream 27, the turbine air stream.

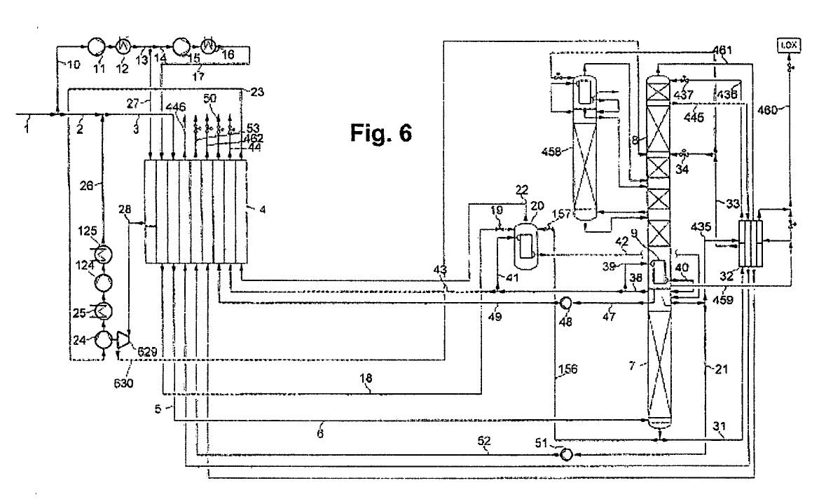

The expander 629 of FIG. 6 reduces pressure to approximately the operating pressure of the low-pressure column. The actively depressurized second air stream 630 is introduced into the low-pressure column 8. Moreover, the process of FIG. 6 is identical to that of FIG. 4.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosures of all applications, patents and publications, cited herein and of corresponding German application No. 102007031759.1, filed Jul. 7, 2007, are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. In a process for producing pressurized gaseous product by low-temperature separation of air in a distillation system, comprising at least one high-pressure column (7) and a low-pressure column (8), in which
A process air stream is compressed in a main air compressor,
At least a part of resultant compressed process air stream (1) from the main air compressor is introduced (6) into the high-pressure column (7), so as to provide an operating pressure,
A first air stream (10, 13, 14, 17, 18), branched from at least a part of said resultant compressed process air stream (1), is compressed to a high air pressure (11, 15, 111), which is at least 1 bar above the operating pressure of the high-pressure column (7),
A liquid product stream (21, 47) is removed from the distillation system, brought in liquid state to an elevated pressure (48, 51), and evaporated or pseudo-evaporated under said elevated pressure by indirect heat exchange (4) with the first air stream (17), and finally drawn off as a gaseous product stream (50, 53),
Whereby the first air stream (17) is condensed or pseudo-condensed by said indirect heat exchange (4),
The condensed or pseudo condensed first air stream (18) is evaporated downstream from said indirect heat exchange (4) with product stream (49, 52), pressurized in the liquid state, in indirect heat exchange (20) with a gaseous stream (41) from the upper section of the high-pressure column (7),
And the resultant evaporated first air stream (22) is recycled (23, 26) into the process air stream (1, 2),
the improvement wherein the evaporated first air stream (23) is compressed in a recompressor (24, 124, 524) upstream from where it is recycled into the process air stream.

2. A process according to claim 1, wherein the evaporated first air stream (22, 23) is heated (4) upstream from the recompressor (24).

3. A process according to claim 1, wherein the indirect heat exchange (20) of the first air stream (18) with the gaseous stream (41) from the upper section of the high-pressure column (7) is performed in a secondary condenser.

4. A process according to claim 1, wherein the gaseous stream (41) is condensed at least partially from the upper section of the high-pressure column (7) in the indirect heat exchange (20) with the first air stream, and the resultant condensate (42) is fed at least partially as reflux into the high-pressure column (7) and/or into the low-pressure column (8).

5. A process according to claim 1, wherein a second air stream (27, 28), branched from the process air stream (1), is work expanded (29, 629), and at least a part of the resultant mechanical energy drives the recompressor (24).

6. A process according to claim 5, wherein the resultant work expanded second air stream (30) is introduced (6) at least partially into the high-pressure column (7).

7. An apparatus for producing pressurized gaseous product by low-temperature separation of air in a distillation system, which has at least one high-pressure column (7) and one low-pressure column (8),
With a main air compressor for compressing a process air stream,
With means (6) for introducing at least one part of the compressed process air stream (1) into the high-pressure column (7),
With a recompressor (11, 15, 111) for secondary compression of a first air stream (10, 13, 14, 17, 18), which is formed by at least one part of the process air stream (1), to a high air pressure that is at least 1 bar above the operating pressure of the high-pressure column (7),
Removed with means for removing a liquid product stream (21, 47) from the distillation system, for increasing pressure (48, 51) in the liquid state, and for evaporating or pseudo-evaporating by indirect heat exchange (4) with the first air stream (17), and with a gas product line (50, 53) for drawing off the evaporated product stream as a gaseous product stream,
Whereby the means for evaporating or pseudo-evaporating by indirect heat exchange (4) are designed as a means for condensing or pseudo-condensing the first air stream (17),
With means (20) for evaporating the first air stream (18) downstream from the indirect heat exchange (4) with the product stream (49, 52), which is pressurized in the liquid state, in indirect heat exchange (20) with a gaseous stream (41) from the upper section of the high-pressure column (7),
And with a return line (23, 26) for recycling the evaporated first air stream (22) into the process air stream (1, 2),
the improvement comprising a recompressor (24, 124, 524) for compressing the evaporated, first air stream (23) upstream from where it is recycled into the process air stream.

8. A process according to claim 2, wherein the indirect heat exchange (20) of the first air stream (18) with the gaseous stream (41) from the upper section of the high-pressure column (7) is performed in a secondary condenser.

9. A process according to claim 2, wherein the gaseous stream (41) is condensed at least partially from the upper section of the high-pressure column (7) in the indirect heat exchange (20) with the first air stream, and the resultant condensate (42) is fed at least partially as reflux into the high-pressure column (7) and/or into the low-pressure column (8).

10. A process according to claim 3, wherein the gaseous stream (41) is condensed at least partially from the upper section of the high-pressure column (7) in the indirect heat exchange (20) with the first air stream, and the resultant condensate (42) is fed at least partially as reflux into the high-pressure column (7) and/or into the low-pressure column (8).

11. A process according to claim 10, wherein a second air stream (27, 28), branched from the process air stream (1), is work expanded (29, 629), and at least a part of the resultant mechanical energy drives the recompressor (24).

12. A process according to claim 11, wherein the resultant work expanded second air stream (30) is introduced (6) at least partially into the high-pressure column (7).
